(19) United States
(12) Patent Application Publication
(10) Pub. No.: US 2003/0033379 A1
(43) Pub. Date: Feb. 13, 2003

(54) Intelligent central directory for soft configuration of IP services

(75) Inventors: Seyhan Civanlar, Red Bank, NJ (US); Ryan Moats, Omaha, NE (US)

Correspondence Address: GREENBERG-TRAURIG, 1750 TYSONS BOULEVARD, 12TH FLOOR, MCLEAN, VA, 22102, US

(73) Assignee: Lemur Networks, Shrewsbury, NJ

(21) Appl. No.: 10/200,065

(22) Filed: Jul. 22, 2002

Related U.S. Application Data
(60) Provisional application No. 60/306,831, filed on Jul. 20, 2001.
(60) Provisional application No. 60/369,772, filed on Apr. 3, 2002.

(51) Int. Cl. G06F 15/16

(52) U.S. Cl. 709/218; 709/230

(57) ABSTRACT

A dynamic activation system which contains an intelligent central data repository which enables service providers to add or alter services and equipment to existing networks by providing a central data store of information which can receive, retrieve, and conform data from one attached operations systems or piece of network equipment for use by all attached operations systems and equipment. The intelligent central data repository provides a directory based storage of global and exchanged local data, determines which systems and equipment require updating, and formats the update or new data for use by each operation system or piece of equipment. The intelligent central data repository can be configured to push or pull data to the operation systems and attached equipment and can analyze the data resident on the attached equipment or operation systems to determine if any data has been altered or added before pushing or pulling data.

This application claims the benefit of U.S. Provisional Patent Application No. 60/306,831 filed on Jul. 20, 2001, and U.S. Provisional Patent Application No. 60/369,772 filed on Apr. 3, 2002, the entirety of each of which is incorporated herein by reference.

### FIELD OF THE INVENTION

The present invention relates to the field of systems integration and specifically, to a unique system and architecture which enables service provider's operational support systems and IP network elements to share and interact with a global data store.

### BACKGROUND OF THE INVENTION

Service providers, such as Internet Service Providers (ISPs), cable operators, broadband providers, satellite TV providers, or the like, must continually plan for the ongoing rollout of valuable new features and services. These new features and services must be integrated into the service providers system or network and must work with the current or existing services and equipment. For example, dial-up internet access will soon be replaced or supplemented by broadband internet access. Broadband access will soon have to be sold with virtual private networks (VPN). Wired access may one day be replaced by mobile access. The list goes on and on as does the cycle. A key challenge facing service providers is ensuring that selected new capabilities work well in the existing information infrastructure of subscribers and systems.

Current physical layer networks, including closely related services such as FR or ATM transport, rely on “static” network configurations whereby a specific sequence of actions to turn-up a port, a device or a single virtual circuit must be completed to enable service delivery to the subscriber. Generally, this sequence of “service provisioning” actions flow under the control of a workflow enabled order-management system. This type of system architecture is ideally matched to services whose configuration does not change outside the context of an order (and a monthly bill) for such service. This process is traditionally called Order-to-Provision Flow. In this context, any changes to the customer's service configuration will be triggered by a Change-Order that normally drives important billing updates.

In contrast to static provisioning of physical-layer networks of channels and equipment elements is the use of Internet Protocol (IP) networking. An inherent characteristic of Internet Protocol (IP) networking is the “dynamic” nature of service definition. This is most evident to service providers who use a traditional Order-to-Provision system for IP services. A complete solution always requires separate administrative IP control systems, often more than one, that must be carefully constrained to prevent subscribers from taking actions that might affect existing orders or billing elements. For example, a customer-accessible (DNS) administrative system must be constrained to allow edits to existing subscriber records, but must redirect users back to a separate Order-to-Provision system should the same subscriber want to change the number of records allowed. No attempt to gloss over these differences at the user interface level can effectively hide the unfortunate and costly fact that the traditional information models for order management and service administration are different.

A perpetual cycle of service innovation is necessary for service providers to remain competitive. In the rush to offer these services, providers struggle with “stovepipe” service infrastructures each with service-specific Operations Supports Systems (OSS), data repositories, and operations organizations. These disjointed systems and infrastructures have been adversely affecting the cost of customer acquisition and maintenance. Moreover, it is difficult to offer bundled voice, video and data services providing subscribers the convenience of an integrated bill or single service management portal. Rapid delivery of such service bundles requires a major integration effort across multiple systems, data and organizations.

To solve these problems, service providers currently have two choices. The first and most trivial option is to create new operations processes (also known as methods and procedures—M&Ps) that define process demarcations. The second option is to integrate the systems pair-wise with custom-built hard-coded adapters which map from one proprietary data to another to enable automated data flow for service provisioning and management. This solution is not only very expensive but also does not scale well with multiple systems and emerging new services.

The prior art systems, as shown in FIG. 1 utilize a systems infrastructure where each of the operational support systems 103, 105, 107, 109 have their own respective data store 113, 115, 117, 119. In order for the OSSs to interact and share data each of the OSSs must be pair-wise integrated to each other. Subsequently, when there is a change or new service implemented or ordered it requires re-provisioning or additional provisioning of the OSSs as well as equipment or devices (not shown).

Many OSS suppliers classify themselves as managing “network” or “customerfacing” operations. Service providers organize themselves around these systems, (“network operations” and “customer operations”) and sometimes billing operation units. Typically when a service order is received, the customer operations unit processes the order by entering the customer account data into the order management system's repository and then forwarding the data manually to the billing and network operations units for further processing. The network group performs the necessary mappings from the customer's location to a service node of the device to port and to line card using a network inventory system which decides the devices in the network which require configuration to activate the service. The network group usually implements the required changes into the network manually. Once the provisioning is completed, the order goes back to the customer care unit to initiate billing and inform the customer about service availability. Typically, service providers attempt to interconnect the network facing OSSs to have a coherent view of the network, or interconnect the customer facing the OSSs to flow the ordering data to the billing system seamlessly. However, there has not been any effort to integrate a customer's service data across network and customer facing systems.

Therefore, what is needed is a system which crosses the network/customer boundary and stitches multiple OSSs into a system which allows for automated service management enabling subscribers to activate new capabilities in real time.

### SUMMARY OF INVENTION

The present invention provides a system which overcomes the obstacles described above by providing a system with a central and global repository of service data which can be shared across the network and customer facing OSSs. This global repository is not the totality of the data across all OSSs but simply the subset of data that needs to be passed “across” the systems for service management. The present invention also provides an integrated Dynamic Service Activation architecture. This unified architecture relies on an information model which forms the basis for both order-based provisioning of new (and changed) IP services and enables the flexible control of administrative updates by authorized subscribers. This unique architecture allows any selected real-time service-affecting action, such as an update, addition or deletion, to be linked or associated with any provider-defined elements thereby allowing subscribers access to the full range of service definition and administrative controls.

The present invention provides a fundamentally stable information infrastructure based on emerging IETF standards that empower service providers to maintain a perpetual cycle of rational service innovation. The present invention uniquely leverages existing services and systems yet positions service providers to deploy new trials or massively scalable services on the same information architecture. In addition, the present invention enables service providers to co-opt selected services and applications provided by others, enabling such services to be offered as cleverly bundled elements that inter-work with an existing base of services.

According to one aspect of the present invention there is provided a system for dynamic service activation of a plurality of internet protocol services comprised of: an intelligent central data repository which utilizes a datastore for the storage of a plurality of information; an internet protocol network attached to said directory which is comprised of a plurality of network equipment and at least one operations systems; and a plurality of data representations which correspond with said plurality of internet protocol services, wherein upon a modification to said plurality of internet protocol services or said plurality of network equipment said system automatically updates the corresponding said plurality of information stored on said intelligent central data repository with a set of new data from said modification, transforms said set of new data from said modification into a plurality of data formats for use by each one of said at least one operations system, and said system updates in real time said at least one operations systems and said plurality of network equipment which interact with plurality of internet protocol services or network equipment was modified. The network equipment may be comprised of an common network equipment including application servers, routers, and customer premises equipment. The operations system might consist of a billing operations system, an ordering operations system, and a network management operations system. Modification to the internet protocol services or network equipment may be an additional service or piece of equipment added or an alteration to the systems or equipment. The present invention may include a web interface and the datastore may be an directory or database. The system of the present invention can update the operations systems or attached network equipment by having the intelligent central data repository push or pull the new data to the operations systems or attached network equipment. The pushing or pulling may be an automatic update established by a periodic time interval. Further, the system has global data representations which correspond with the internet protocol services and exchanged local data representations which mirror the data stored in each operations systems, wherein the exchanged local data representations are exchanged across the plurality of operations systems to activate the internet protocol services. The datastore may be a directory or database.

According to another aspect of the present invention there is provided a method for activating an internet protocol service utilizing a dynamic activation system comprising the steps of: accessing an ordering operations system, from a plurality of operation systems, using a web browser and entering a plurality of subscriber information and a plurality of subscriber device and service information; wherein said ordering operations system updates said plurality of subscriber information and plurality of subscriber device and service information located in an intelligent central data repository; creating a set of exchanged local data and a set of global data representations by said intelligent central data repository; determining which of said plurality of operations systems need updating from said set of exchanged local data or said global data representations; updating said plurality of operations systems which need updating with said set of exchanged local data or s aid global data representations; determining an internet protocol address and a configuration file corresponding to said internet protocol service by said intelligent central data repository; updating a plurality of server information with said internet protocol address and said configuration file by said intelligent central data repository; updating a monitoring operations system, from said plurality of operations systems, with said internet protocol address and said plurality of subscriber device and service information; and transmitting said configuration file to a subscriber device for activation. The present invention can also performs the data updating through the intelligent central data repository by pushing or pulling exchanged local data to the appropriate operations systems or equipment. The intelligent central data repository also determines which operation systems and equipment require updating by the exchanged local data.

### BRIEF DESCRIPTION OF DRAWINGS

FIG. 1 is a traditional architecture of the service provider system showing pair wise data sharing.

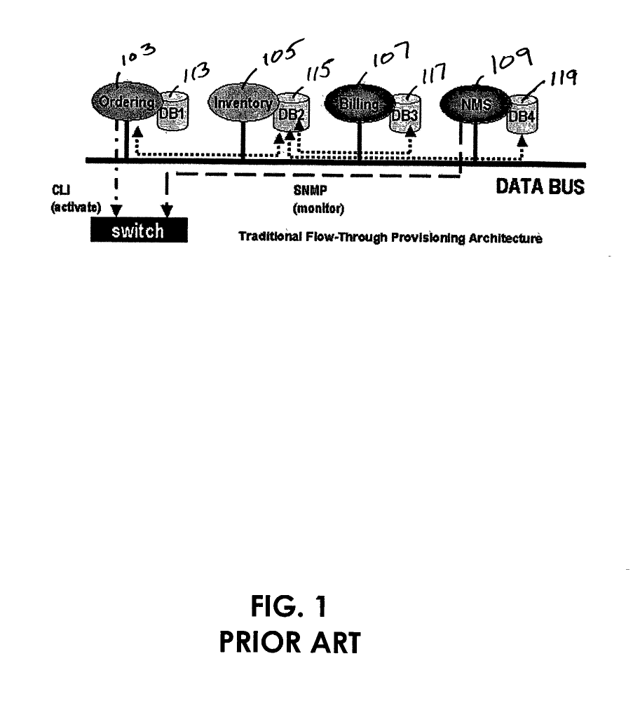

FIG. 2 is a schematic diagram of the present invention showing a directory enabled network information store.

FIG. 3 is an exemplary embodiment of the present invention.

FIG. 4 is another embodiment of the present invention.

FIG. 5 is a block diagram of the information model of the present invention.

FIG. 6 is a partial object list of the information model.

FIG. 7 is a block diagram of the dynamic service activation touch points.

FIG. 8 is an architectural concept diagram of the various interfaces of the present invention.

FIG. 9 is an exemplary embodiment of the present invention.

### DETAILED DESCRIPTION

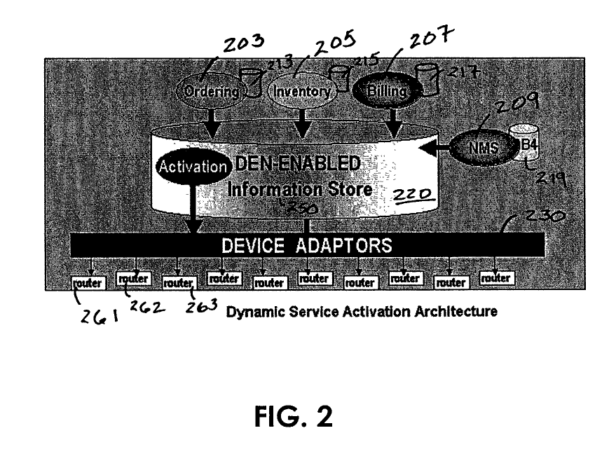

The system and architecture of the present invention will now be described in conjunction with FIGS. 2-9. The present invention provides a system which overcomes the obstacles described above by providing a system with a central and global repository of service data which can be shared across the network and customer facing OSSs. This global repository is not the totality of the data across all OSSs but simply the subset of data that needs to be passed “across” the systems for service management. The present invention also provides an integrated Dynamic Service Activation architecture. This unified architecture relies on an information model which forms the basis for both order-based provisioning of new (and changed) IP services and enables the flexible control of administrative updates by authorized subscribers. This unique architecture allows any selected real-time service-affecting action, such as an update, addition or deletion, to be linked or associated with any provider-defined elements thereby allowing subscribers access to the full range of service definition and administrative controls.

The present invention provides a fundamentally stable information infrastructure based on emerging IETF standards that empower service providers to maintain a perpetual cycle of rational service innovation. The present invention uniquely leverages existing services and systems yet positions service providers to deploy new trials or massively scalable services on the same information architecture. In addition, the present invention enables service providers to co-opt selected services and applications provided by others, enabling such services to be offered as cleverly bundled elements that inter-work with an existing base of services.

The present invention provides Dynamic Service Activation which is ideally suited for both provisioning and administering updates to subscriber's IP services and IP-related vertical applications. The present invention is designed to interact and integrate the systems and devices which had previously been deployed and the configuration of the existing physical network of IP-enabled components. More importantly, the present invention enables rapid and continuous introduction of new services on top of a common information model. New services are defined exclusively by a set of manipulations to data constructs in the existing systems.

The breadth of IP services and applications suitable for Dynamic Service Activation includes: (1) Bandwidth Rearrangements; (2) Policy changes, (3) network events; (4) session driven applications; (5) media applications; and (6) administration of hosted applications.

Bandwidth Rearrangements is inherently an issue for IP networks since resources such as access bandwidth is shared across many applications. Certain applications may need higher priority treatment when they compete with other applications for the same bandwidth. Thus, as the volumes of traffic between applications shift, the user reassigns the access bandwidth coarsely across applications. Internet Protocol enables such controls by configuring the packet processing queues in customer's access router and by altering packet's Quality of Service (QoS) markings to enable preferential treatment as packets traverse the IP network. Differentiated Services (DiffServ) provides mechanisms readily available in standard IP routers.

Policy Changes such as security policies that define the encryption strategy between particular sites of the user may require frequent updates as new users and LAN segments are added to customer's site or as new sites are configured. Network Events such as hard failures or performance bottlenecks may require network resources to be remapped between users, services and sites. Session Driven Applications such as video or audio conferences across the public Internet requires a per-session fine-granularity allotment of resources and scheduling or the session. Media applications that are delivered to the users using the same broadband access pipe such as Cable can be configured on an on-demand basis. Although these applications are tailored more towards households a similar services activation infrastructure to those of enterprises would be needed. Administration of Hosted Applications is needed as industries are moving to offer products and services online which will enable and/or provide enterprises who subscribe to web hosting or e-commerce services the ability to self-administer their applications.

However, to establish a system which can provide real time dynamic service activation the operating systems and network equipment must be able to obtain added, modified, altered data relevant for their interaction within the system. Further, to prevent constant manual re-provisioning of each piece of network equipment and each operating system there needs to be a platform which both operating systems and network equipment can communicate with in a manner which retrieves and transmits data to all appropriate systems. The architecture and system of the present invention provides such a system.

As seen in FIG. 2, the present invention provides a Directory Enabled Networking (DEN) meditation platform 220 with device adaptors 230 and a single consolidated information store 250. Note that the legacy OSSs 203, 205, 207, 209 attach to the mediation platform 220 and exchange data between the local repositories 213, 215, 217, 219 and the global central repository 250 in order to ensure data flow between OSSs 203, 205, 207, 209.

The central and global data repository which stitches the service provider's operations support systems 203, 205, 207, 209 and IP network elements together enables automated service delivery. The present invention is used to create new services by simply changing or adding data in a central place 250 where appropriate elements of the data are propagated into attached OSSs 203, 205, 207, 209 for proper operations support functions. Additionally, the present invention provides real-time and batch data operations.

The Mediation Platform 220 is ideally suited for rapid service creation and flexible service activation for IP networks. The mediation platform 220 provides the first instance of a device-independent service activation mechanism. The mediation platform 220 also treats service activation as a standalone process and ties it into subscriber defined policy and configuration changes and desired sets of legacy Operations Support Systems (OSS) 203, 205, 207, 209. Different types of devices such as routers 262, 262, 263 and cable modems (not shown) are easily controlled by the platform 220 with installation of new Device Drivers.

The mediation platform 220 of the present invention may utilize a Lightweight Directory Access Protocol (LDAP) Directory which uses the most recently published Common Information Model (CIM) object model for the core of the platform and Directory Enabled Networking (DEN). The mediation platform 220 also provided the following innovation elements: (1) an integrated view of services, devices, users and policies defined in a completely product independent fashion; (2) single distributed repository with an extensive object model with close to 1,000 objects that uses CIM and Lemur service objects; (3) means for activating dynamically access devices for services such as virtual private networks as well as hosted services such as e-commerce or media services such as Walled Garden sites for Interactive TV; (4) directory technology which enables the Directory to detect changes in service attributes and create either a push or a pull action to execute proper changes in the target applications or devices; and (5) inclusion of gateways to legacy OSSs and applications that are not DEN-ready yet. These Gateways translate LDAP queries into appropriate formats to communicate on different types of interfaces. Such Gateways are XML, Java, SNMP and CLI.

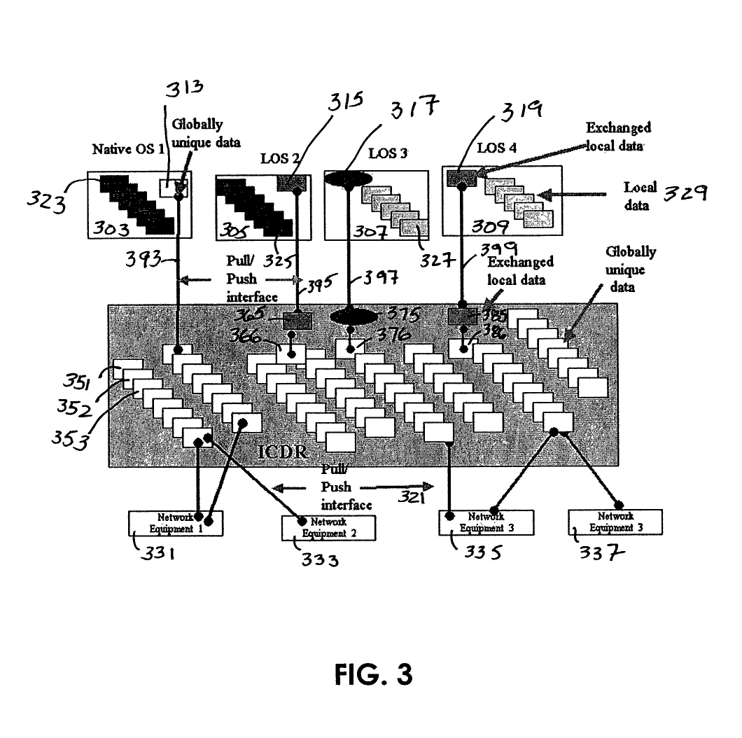

As seen in FIG. 3, the present invention is a System that consists of at least one intelligent central data repository (ICDR) 320 using a Directory which attaches to an IP network which consists of network equipment 331, 333, 335, 337 and Legacy Operations Systems (LOSs) 303, 305, 307, 309. The network equipment 331, 333, 335, 337 may consist of application servers, routers, switches, customer premises equipment (CPE), physical and data link layer equipment, transmission facilities, or any network equipment. The Legacy Operations Systems 303, 305, 307, 309 may consist of billing, ordering, work-flow management, network management systems, or other operations systems. The architecture of the present invention and the ICDR which contains a globally unique open-standard data representation of all IP services allows any user to subscribe and/or dynamically activate these services on network equipment without altering the physical network configuration at the physical, data link and routing layers (hence the “soft configuration”). One example would be the activation of voice services such as 1-800, call forwarding and three way calling, in a telephony network without altering the underlying physical transport network configuration.

Additionally, the System of the present invention can employ a web interface to ICDR 320 which enables the users to access the System via HTTP (RFC 2616) to administer their user services parameters. Users could administer their service parameters by changing service attributes, adding new services and/or deleting services which causes changes to be immediately stored in the central repository 320. The activation or reactivation of service happens by (1) the network equipment 331, 333, 335, 337 “pulling” new configurations into the affected network equipment 331, 333, 335, 337, or (2) by the ICDR 320 signaling (using a “trigger” feature) the affected network equipment 331, 333, 335, 337 to stimulate the need for a “pulling” action from the network device for the new information from the ICDR 320 or (3) the ICDR 320 pushing the data.

In accordance with the present invention, the trigger and pull mechanisms include the ICDR's 320 ability to associate user services to affected network equipment 331, 333, 335, 337, and the method to make the network equipment 331, 333, 335, 337 ask for new configuration update from the ICDR 320. One method of transmitting a “trigger” signal is through the use of XML on an electronic interface. One method of creating the “pulling” feature is through the use of Lightweight Data Access Protocol (LDAP) (RFC 2251).

The LOSs 305, 307, 309 offer functions that are pertinent to IP service activation and they are an essential component of the service delivery. The LOSs 305, 307, 309 will also attach to the ICDR 320. Each of the LOSs 305, 307, 309 will have at least one electronic interface. Each LOS 305, 307, 309 normally comes with a local (or remote) data repository such as a database, text files, or a directory, with locally defined proprietary data representations about users, services and network equipment. Some LOSs 305, 307, 309 may not have a local data store and thus completely rely on the ICDR's 320 data store. The System of the present invention may have one or more integrated Native Operations Systems (NOS)s 303 such as an ordering system that solely relies on the ICDR 320 as the local data repository (or its local data repository would have the same globally unique data representations as the ICDR 320).

In accordance with the present invention, the ICDR 320 stores the global data representations 351, 352, 353 and can pass the same global data, represented differently across multiple LOSs 305, 307, 309, by using the electronic interface 393, 395, 397, 399 to each local repository 313, 315, 317, 319 as it stores the master data representation of each data element. Use of the ICDR 320 is a preferred method over each pair of LOSs 303, 305, 307, 309 exchanging data elements as peers and possibly translating between different representations. Further, because the present invention uses an ICDR 320, each LOS's local data store 323, 325, 327, 329 synchronizes with the global ICDR 320 (the “master”). The system is designed so that some of the data stored in the local store of each LOS will be used solely for the internal functions of the LOS and will not be exchanged with other LOSs and therefore, such data will not be replicated within the ICDR 320 as it does not appear outside the scope of the LOS. As new data arrives into the local repository 313, 315, 317, 319, configured either by a systems administrator or user, it gets pulled/pushed and stored by the ICDR 320 and becomes ready for retrieval by other slave LOSs 303, 305, 307, 309 connected to the ICDR 320. The ICDR 320 can also store the local representation of the data that is only exchanged across LOSs 303, 305, 307, 309 and the association of these local representations into the globally unique format.

In accordance with the present invention, the system incorporates pulling and pushing capabilities. The Pulling and Pushing capabilities used for the interaction between the ICDR 320 and network equipment 331, 333, 335, 337 is also used between the ICDR 320 and the LOSs 303, 305, 307, 309. Therefore, the ICDR 320 can push to data to a particular LOS in the local format understandable by that LOS as if it is the user of that system. Alternatively, the other LOSs can “pull” data from the ICDR 320 and store such data using their local format. The ICDR 320 can also provide a web portal for a System Administrator to: (1) describe the LOSs (brand and type) and network equipment (brand and type) which are electronically attached to ICDR 320; (2) select the data elements which must be translated between the ICDR 320 and each local data store 323, 325, 327, 329 to represent IP services; and (3) to specify each piece of network equipment 331, 333, 335, 337 and the association between user services and the network equipment 331, 333, 335, 337.

In addition, the ICDR 320 interfaces with each LOS 303, 305, 307, 309 and each piece of network equipment 331, 333, 335, 337 (such as routers and server) affected by a service activation by using the “Pulling” and “Pushing” methods and treats them exactly the same from the perspective of data flows, and hence a very efficient operations. The protocols used for “pull” and “push” may be different depending on the device and LOS type.

An example of the use of the system of the present invention will now be described in conjunction with FIG. 3 where a broadband service provider such as a cable operator is using the ICDR 320 infrastructure for the activation of cable modems. In this scenario, the NOS 303 might be a provisioning system that relies on the ICDR 320 as the native datastore. The cable operator has an ordering system LOS 305 with a local database 325, a billing system LOS 307 with a local database 327, and a network monitoring system LOS 309 with a local database 329. The Network Equipment might include such devices as a cable modem 331, a Cable Modem Termination System (CMTS) 333, a Dynamic Host Configuration Protocol (DHCP) server 335, and a Trivial File Transfer Protocol (TFTP) server 337. For this example, the CMTS 333 is located at the cable operators head end office, is connected to Cable Modems in a service area with a Hybrid Fiber Coax (FHC) distribution system, and runs the IP protocol on top of DOCSIS protocol which is a data link layer protocol. The DHCP server 335 is used to assign IP addresses to Cable Modems and the TFTP server 337 is used to download IP configuration files onto Cable Modems. The Cable Modem 331 runs a DHCP client and a TFTP client to communicate with the DHCP server 335 and the TFTP server 337. In this example, the operations flow to activate a new Cable Modem service running High Speed Internet Access using the ICDR 320 is as follows:

1. The Customer Service Representative (CSR) or Subscriber accesses the Ordering System LOS 305 using a web browser and enters subscriber specific data such as name, address, telephone number, ordered service features (bandwidth, number of IP addresses, number of email boxes etc.). Additionally the Medium Access Control (MAC) address of the Cable Modem is entered into the LOS 305 by the CSR or Subscriber.

2. The Ordering System LOS 305 pushes all the newly entered data into the ICDR 320. If the Ordering System LOS 305 can not push the data for some reason the ICDR 320 can poll the LOS 305 for any new data on a periodic basis and upon notification of such new data will trigger LOS 305 to send a batch of new data to the ICDR 320.

3. The ICDR 320 creates the Exchanged Local Data 365 as well as the corresponding Global Data representations 366 within the ICDR 320. Simultaneously, the ICDR 320 determines which other systems or equipment should know about the newly created data. This determination is done through the Information Model, which will be described in more detail below, which defines object associations within the ICDR 320 or alternatively an application that runs in the ICDR 320.

4. The ICDR 320 maps the newly created Global Data 366 to the corresponding Exchanged Local Data format 375 of the Billing System LOS 307 and pushes the Data in Exchanged Local Data format 375 of the Billing System LOS 307 into the LOS 307.

5. Simultaneously, the ICDR 320 makes a determination of an IP address from its repository of free and available IP addresses and the required configuration file corresponding to the customer's service settings for the new Cable Modem. The configuration file may be compiled in real time or can be pre-stored based on typical customer service choices.

6. The ICDR 320 pushes the new IP address and the configuration file pointer or index into the DHCP server 335.

7. The ICDR 320 pushes the IP address and MAC address of the Cable Modem 331 to the network monitoring system LOS 309 to start monitoring the system when it is configured.

8. When the Cable Modem 331 is powered up it will send a DHCP request query to the DHCP server 335 which in turn responds with a DHCP response that contains the IP address assigned to the Cable Modem 331 and the Configuration File index. In turn, the Cable Modem 331 sends a TFTP request to the TFTP server 337 with the Configuration File Index contained in the request. The TFTP server 337 in turn sends the Configuration file which gets uploaded on the Cable Modem 331 and configures the Cable Modem 331 with bandwidth settings that correspond to the bandwidth purchased by the customer.

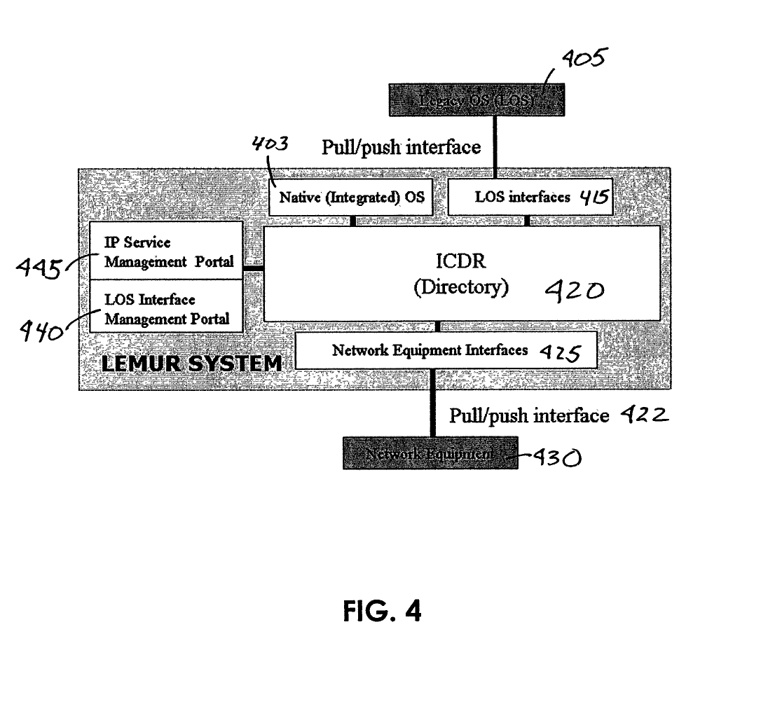

In a preferred embodiment, as seen in FIG. 4, the ICDR 420 will be pre-configured with the required basic objects to activate IP services. The LOS Interface Management Portal (LIMP) 440 will be used by the System Administrator to specify: (1) the IP services available to users; (2) how each LOS 405 which interface with the ICDR 420 and which data elements will be exchanged between an LOS 405 and the ICDR 420; (3) how each piece of Network Equipment 430 will interface with the ICDR 420 and which data elements will be exchanged between the Network Equipment 430 and the ICDR 420; and (4) how each electronic interface 415 between an LOS 405 and the ICDR 420 and each network equipment interface 425 between the Network Equipment 430 and the ICDR 420 interacts. In most cases, IP address, port id and protocol type would suffice to describe the electronic interfaces 415, 425. The LIMP 440 will provide drag-and-drop user-friendly mechanisms to associate the corresponding local and global objects in the respective LOS 405 and ICDR 420 repositories.

Once the ICDR 420 is configured with the users' IP services, the LOSs 405 and Network Equipment 430 the user or System Administrator will be provided with the protected IP Services Management Portal (ISMP) 445. This portal 445 enables the user to enter requests such as (i) creating an IP service, (ii) changing features or an IP service, or (iii) activating/deactivating an IP service. The ISMP 445 will propagate such requests to the ICDR 420 and make appropriate changes in the central repository. These changes will propagate to appropriate local (replicated data) within the ICDR 420 to reflect the changes in the master data. After all changes are executed, the “activation signaling” process within the ICDR 420 server will handle the synchronization of the ICDR 420 with the affected network equipment 430 and LOSs 405 (if needed).

An important enabler of dynamic IP service activation provided by the present invention is the timely transmittal of configuration changes executed as object changes within the ICDR 420 to the affected LOSs 405 and network equipment 430. Activation is achieved in three steps: (1) the user enters a change request through a web portal; (2) changes are propagated to the ICDR 420 as object changes; and (3) the ICDR 420 transmits the changes to network equipment 430, and sometimes, to one or more LOSs 405.

In the preferred embodiment, the ICDR 420 will use Directories at its core. Directories define ways of structuring and storing data, but they do not define ways to synchronize data with other data stores and systems when a change occurs within. Directories in the prior-art are utilized through queries initiated by an external system (e.g., an LDAP request). Currently, there is no mechanism for properly synchronizing a Directory with other systems such as those in LOSs or with network equipment for activation signaling. One of the key operations of the system of the present invention is to transmit/relay (“change-relay” or “activation signaling”) any new or updated data (such as an object) within the directory to all peripheral remote systems such as the LOSs, Native OSs (NOS)s, and network equipments in a timely manner. The remote system may contain a repository which stores data in a local format or may not have a data store but a simple configuration file. An example of a system that does not have a local data store for service configuration would be a router and/or a cable modem.

When changes happen within the ICDR 420 the remote systems will not know about such changes unless a mechanism is used by the ICDR 420 to inform the remote system about the fact that a change has happened. The aforementioned relaying can be done in different ways. According to one aspect of the present invention, each object that needs a change relayed to a system (such as a piece or pieces of network equipment, a NOS or a LOS) has an object associated with the changed-object (data) that has remote-object properties. These remote-object properties might include: (1) the type, brand, IP address and port of the system(s) that the change must be communicated to; (2) the type of change-relay mechanism (periodic pull, on demand pull, trigger and push); (3) the status of the change-relay (in-progress, completed, failed, etc.); and (4) the associated LOS object stored in the ICDR 420 when the change-relay is sent to an LOS that stores the object in a form other than the globally unique form.

There are four methods for accomplishing the “change-relay” or activation process which include: (1) Periodic Pull; (2) Pull on Demand; (3) Trigger; and (4) Push.

Periodic Pull

When an object is created/deleted or modified within the ICDR, the network equipment or LOS can learn about the change by periodically pulling data from ICDR, in which case ICDR may only transmit the changed data. If there is no change from previous polling, ICDR will send a “null” response to the periodic pulling request indicating “no change”. One possible method by which the “periodic pull” action can be attained is by period LDAP requests to the ICDR in which case ICDR responds back with an LDAP response.

Pull on Demand

When LOS or network equipment receives a request from an application (such as the web based management console) for which it cannot associate any data within the local data repository, that LOS or network equipment will initiate a “pull” using a protocol such as LDAP.

Trigger

When the ICDR notices a change within an object for which a “periodic pull” or “pull on demand” has not been initiated (or will never be initiated), it can send a “trigger” to the remote system to initiate a pull on demand. Such a mechanism is needed when the change in the Directory (for example deletion of an email account object) will never cause an external system to send a pull on demand (since there will be no one that accesses that email account after the deletion). In such a case, the ICDR will autonomously create a “trigger” to the remote system associated with the change to stimulate a pull on demand.

The “trigger” is not specific to any type of object. It is a common action across all objects in the Repository. The objects (or actions on the objects) that will need to cause a “trigger” has a specific attribute indicating that a trigger is needed, without needing to store any specific “trigger” data or code as an attribute of the object. When the “triggering” change occurs in the Repository, the server process in the ICDR notices “a trigger indication attribute” along with the changed object, fetches the required remote-object properties to determine where to send the trigger, and changes the “change-status” to “in-progress”. When the trigger is received by the remote system, it sends a standard message to the ICDR to fetch the object (or the change). The ICDR, upon receipt of the message, fetches the data needed from the global repository, and makes the appropriate translation to local data format, if local and global data formats and names are different, and sends the data as a response. Upon completion of the change-relay, the status of the change-relay is changed to “completed”. One of the advantages of this invention is that, the trigger is identical across all objects and all remote systems since there is nothing remote-application specific coded within the trigger. This mechanism allows, the System to interface with many different types of systems using a single unified method. An example trigger is:

trigger=refresh LDAP object-I from LDAP store X.

The trigger execution requires a corresponding program running on the remote system, which, upon receiving the trigger, will invocate the pull on demand action. Periodic pulling may be used in conjunction with the trigger and pull on demand methods for complete update (and clean up) of the entire data in the remote system.

Pushing

When the ICDR notices a change within an object for which a “periodic pull” or “pull on demand” or “trigger” can not been initiated, it can send the actual changed object to the remote system in a message. Such a mechanism is needed when the change in the Directory will never cause an external system to send a message to pull the data. An example would be a router or cable modem which only supports a “push” interface such as the Command Line Interface (CLI). In such a case, the ICDR will create the message using the format the LOS/NE would support and push the data down.

Information Model

Another aspect of the present invention is the Information Model (IM) which is a data representation of an entity being managed within a given service provider's operations environment. The Information Model (IM) includes the definition of the managed entity, the operations that can be performed on it, and the attributes and relationship to other data in the information model. The information model is the totality of the data stitched together. The present invention folds the data modeling aspects, such as data access protocol, repository type and data structures under the information model. Further, the information model provides the framework that becomes the “unified” data representation to move managed-data across a service provider's systems. The word “managed-data” is used to represent the data, which models the service management aspect. The present invention utilizes an object-oriented Information Model (IM) which resides within a data repository and attaches to the IP network by either attaching directly to network devices or their element management systems (EMS) or servers which host applications or administrative functions.

The information model is formed by building an implementation-neutral data model describing the provider's service management operations. The present invention is designed to reuse existing common data models standards bodies built to create an interoperable implementation. The system leverages object design principles to enable abstraction, classification and inheritance. The information model also becomes the authoritative data of the system. Through use of the information model the present invention can communicate event occurrences such as changes in the global data to adjacent OSSs and can enable batch data operations to handle multiple data changes to implement a single service change. The information model provides an extensible data representation to easily add new service representations and is constructed with a modular design using a “plug-and-play” approach.

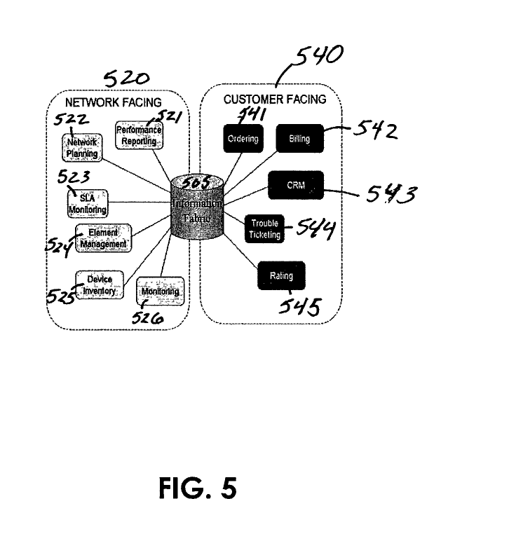

As seen in FIG. 5, the information model is the first step in building the information fabric 505 that interweaves and interconnects the network facing 520 and customer facing 540 operations and systems. The network facing system might include all or some of the following: performance reporting 521, network planning 522, SLA monitoring 523, Element Management 524, Device Inventory 525, and monitoring 526. The Customer Facing systems might include all or some of the following: ordering 541, billing 542, CRM 543, trouble ticketing 544, and rating 545. The network facing 520 and customer facing 540 systems listed herein is not considered exhaustive and either could add or delete systems including systems not specifically mentioned herein.

The Information Model utilized by the present invention provides an interoperable data representation used across network devices and systems and uses policy driven operations of IP network management using directories as the data repository. Further, the present invention uses a subset of objects defined by CIM and IETF Information Models. The system leverages objects for concepts such as Network, Device, Interface, User, Account, Service, and Policy, and extends them to represent the service provider's operations environment. Concepts such as OSS, Pricing, and Delegated Administration are part of the extended information model. These extensions can be standardized to make the data available to providers of network equipment and systems.

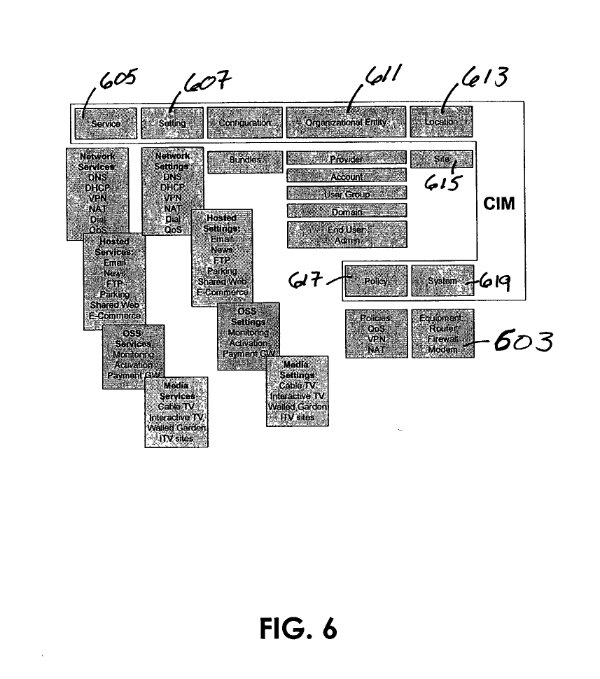

FIG. 6 shows a partial object list of the Information Model. As seen the object lists covers the equipment 603, Services 605, Settings 607, Bundles 609, Organizational groups 611, the location 613, site 615, policy 617, and OSSs 619. The equipment objects 603 model the equipment used to provide services. The services objects 605 model can all types of services including network, hosted, OSS, and media based services. The service objects 605 provide the information on what services are supported by what pieces of equipment and are used by AppBinder and the legacy gateways to determine which setting objects to apply. The settings objects 607 provide the particular equipment settings to be applied by AppBinder as part of dynamic service activation. The bundles object 609 allows the services to be logically grouped into bundles. The bundles can be created by an additional software application which allows service providers to select and bundle different services, This allows service providers to target service bundles to be offered to meet specific market needs. The organizational groups object 611 cover users and groups of users providing flexible delegated administration and customer control. The location object 613 and site object 615 model information related to equipment location and is used in modeling applications (like VPN) that are tied to specific customer sites. The policy objects 617 provide the framework for policy decisions at all points of the service activation and delivery process. Finally the OSSs objects 619 provide information about the OSSs that need to be attached to the platform.

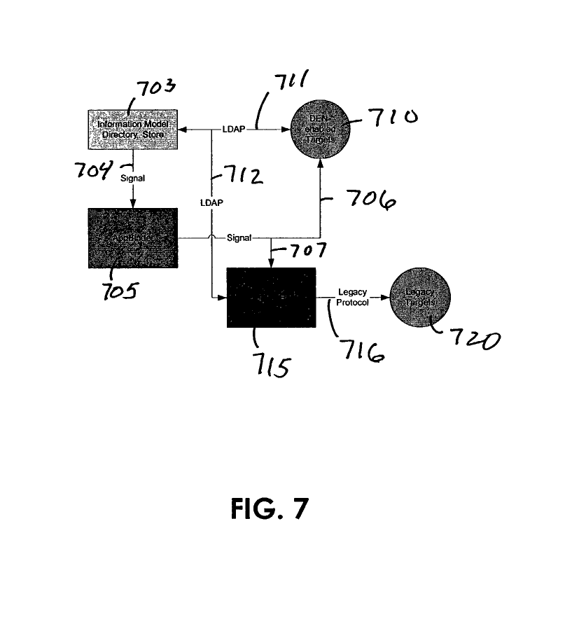

Another feature of the present invention, as seen in FIG. 7, is that the dynamic service activation of applications is possible through several touch points. Since the system automatically detects modifications or changes of services or customer specific applications such changes can be implemented at different points. The system, as defined in the directory, can activate new capabilities by signaling the service delivery platform(s) 705 using out-of-band signaling. As shown in FIG. 7, the application binder 705 can receive out of band signals 704 from the Information Model Directory Store 703. The AppBinder 705 can transmit out of band signals 706, 707 to the Den-enabled targets 710 or to the Legacy GW 715. The DEN-enabled targets 710 and Legacy GW 715 are in electronic communications with the Information Model Directory Store 703 via communications paths 711 and 712 respectively. In the preferred embodiment the communications will utilize the Lightweight Directory Access Protocol (LDAP). The Legacy GW 715 transmits the pertinent data to the legacy targets 720 through communications path 716 which can transmit the signals in the legacy protocol of the legacy targets 720. The Directory AppBinder 705 can include device drivers for legacy OSS, applications and CPE devices.

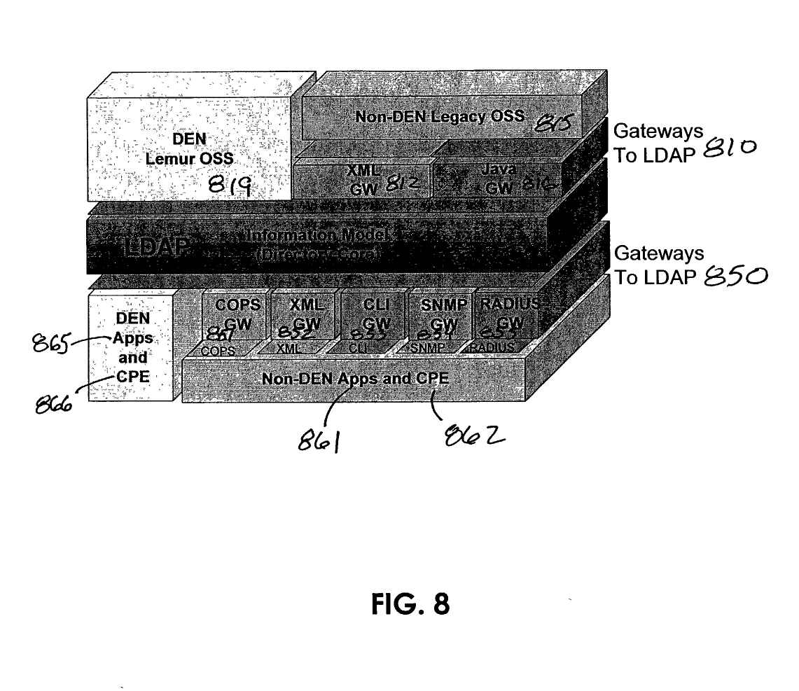

As seen in FIG. 8, the system of the present invention a also provides customized interfaces to support legacy CPE devices 860, applications 861 and legacy OSS 815. These interfaces are supported by gateways 810, 850 that adapt to the Information Model 820 of the present invention. As shown in FIG. 8, the present invention supports XML 812, 852, Java 816, COPS 851, SNMP 854, CLI 853 and RADIUS 855 interfaces via gateways 810, 850 which can be built from open-source code bases. The system also supports DEN enables OSS 819 and DEN enabled Applications 865 and CPE devices 866.

Directories

As previously mentioned, the present invention uses a Directory for its data repository. Directories have several salient characteristics. First, the storage of information in a Directory is optimized so that it can be read much more frequently than it is written. This makes directories ideally suited for operations that require high-volume searches. Examples of such searches are authentication of email users using user credentials, AAA functions of dial VPN users, or domain to IP address resolution. The service management operations are heavily read oriented, and thus, directory is an ideal match. The present invention makes use of the Internet Engineering Task Force (IETF) standardized and simplified Directory access protocol called Lightweight Directory Access Protocol (LDAP). The LDAP protocol makes use of TCP/IP protocol stack and provides only the most needed functions of the far more complex X.500 Directory access protocol. Thus, the Directories are easily incorporated into an IP network with the LDAP protocol.

Second, Directories provide a unified namespace where multiple applications can tap into the same data within a Directory. A unified namespace enables the integration of data such as user information, accounts and servers within IP network devices. Finally, Directories can efficiently distribute data among various directories that comprise a Directory Service through a protocol called Directory Replication. Directory Replication is an important aspect of large-scale data management since a single repository with no replication will not meet a service provider's requirement reliability. Moreover, directory replication supports heterogeneous distributed Directory implementations. The changes will be replicated between many remote LDAP servers without clients having to perform any extra operations to request the replication of data. Replication is typically performed between a Primary Directory and one or more Secondary Directories. The secondary directories store a copy of the information in the Primary Directory for extra reliability. Using replication, a Secondary Directory receives changes to the data entries in the Primary Directory and updates its data to ensure both Directories are in sync.

Real-Time Operations

Since, a Directory operates using a query/response mechanism it is a “passive” element which is adequate for devices that only use directories at startup and only need to pull data once. However, for more complicated service management systems where a user might change the service parameters by altering data elements stored in the Directory there is no inherent Directory synchronization mechanism to sense the change in the data elements and autonomously reconfigure appropriate devices. Although CIM 2.5 protocol provides event notification objects there is no mechanism to define how these messages will be triggered.

As previously described, the present invention incorporates a pull function or feature whereby the network equipment is configured to periodically pull the data pertinent to equipment configuration from the LDAP Directory. If the data is different than the configuration settings stored in the equipment than the configuration settings data will be updated. The present invention can require that a data change be necessary to ensure the configuration data in the LDAP Directory and network equipment are always identical. In a more preferred embodiment the present invention is designed to detect only the changes in the data stored that represents the device or server settings and the system pushes the data into the appropriate equipment only when there is a change.

Another issue with the use of Directories for network provisioning occurs when a service or network provisioning action requires multiple network touch points to complete the new configuration. Such an example would be when a customer or subscribers adds or changes equipment such as a cable modem or router. Such scenarios require additional capabilities to handle the transactions and to coordinate successful completion of multiple tasks. While Directories do support the concept of atomicity of changes to a single entry stored within the Directory there is no inherent logic in the Directory to enable a successful execution of multiple changes throughout the network. Multi-entry changes are typically needed for completing a service change that requires configuration modifications in multiple pieces of equipment such as a cable modem and a cable modem termination system (CMTS) simultaneously. The preferred embodiment of the present invention overcomes these difficulties by implementing a unique architecture.

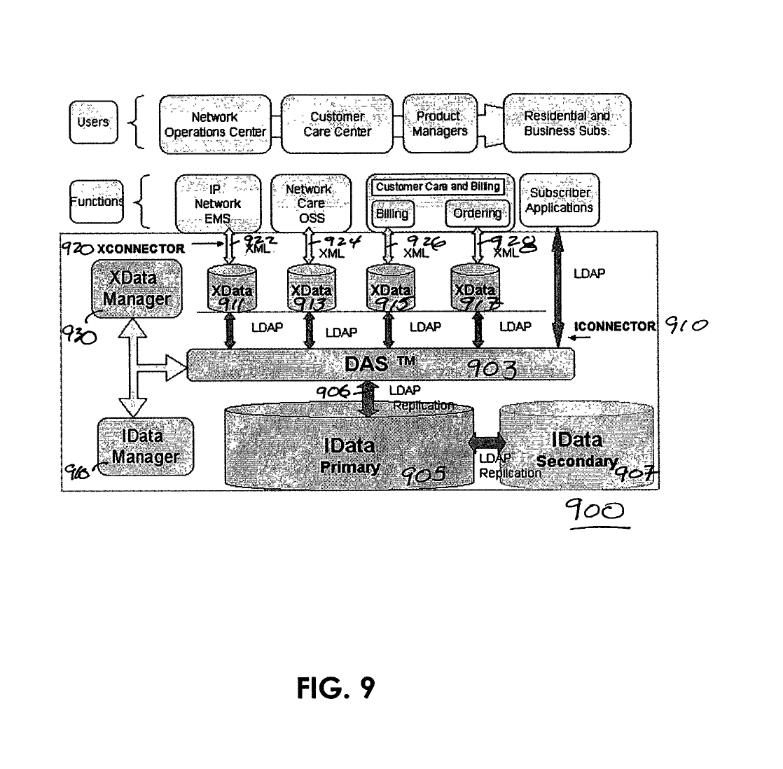

In an exemplary embodiment 900, as seen in FIG. 9, the Dynamic Activation System 903 of the present invention stores the global data according to the Information Model defined by DMTF CIM, IETF and X.500 with new extensions to make it ideally suited for service management. The Systems (both network and customer facing) and IP network components, such as servers and applications, attach to the DAS 903. The service middleware enables activation and management of IP services such as basic CPE configuration, IP telephony, bandwidth and QoS services, VPN and firewall, hosting, email, domain name services (DNS) and IP address services (aka DHCP). All of these services are primarily CPE or server driven with relatively few network touch points.

The exemplary embodiment of the present invention 900 has three main components which include: (1) data stores; (2) connectors; and (3) data managers. The data stores hold both global and a subset of attached systems data and consist of IDATA 905, 907 and XData 911, 913, 915, 917. IDATA 905, 907 is the global information model (IM) stored within an LDAP Directory. IDATA 905, 907 represents high-level abstractions of services, devices, users, and accounts. The high-level abstract objects enable rapid new service creation through recombination of existing objects and associations, as well as the creation of new objects in an orderly manner to properly manage a new service. XDATA 911, 913, 915, 917 is the subset of IDATA 905, 907 that pertains to a specific external system. This subset of data is used with the external system for flow-though service activation. XDATA 911, 913, 915, 917 may be stored in either the external system or a local data store.

Connectors orchestrate the data exchange between different data stores and between data stores and external systems and include I-Connectors 910 and X-Connectors 920. These Connectors 910, 920 handle the transactional nature of data manipulations and data synchronization. The I-Connectors 910 provide the mapping between the XDATA 911, 913, 915, 917 and IDATA 905, 907 using the LDAP protocol. The I-Connector 910 contains the middleware components, such as the Directory Activation Server (DAS) 903, to enable data “push” and transaction handling and the data connections 912, 914, 916, 918, 906. The DAS 903 relies on an innovative variant of LDAP replication to capture only those changes that pertain to the connector and delivers the successful transaction after changes are executed to the external system. The X-Connector 920 consists of the communications paths 922, 924, 926, 928 which provide the required data update between XDATA 911, 913, 195, 917 and the main data repository of the external system. The X-Connector 920 can use a variety of communication methods ranging from XML to proprietary API calls.

The Data Managers includes an X-Data Manager and an I-Data Manager and handle data manipulations. The X-Data Manager is a utility that provides a User Interface (UI) and applications to allow the service provider to design and configure the system with attachments to selected systems. The X-Data Manager 930 enables the user to select the data to be exchanged. The IData Manager is a utility that provides a user interface to the service provider to extend the IDATA schema and performance. The IDATA schema is extended by adding new classes and associations to the information model and by “compiling” this model into a new IDATA schema. IDATA performance monitoring checks the central repository to ensure that I-Connectors 910 and X-Connectors 920 are able to access necessary data quickly and accurately.

As described above the present invention provides a system which stitches data across multiple systems and can eliminate Service Provider's inflexible and expensive stovepipe service infrastructures. The present invention's use of a data driven approach with a global information model provides a unique, novel, flexible, and expandable framework. The present invention allows for real-time data integration and synchronization between systems and equipment and enables subscribers to instantly configure service parameters and providers to instantly create brand new revenue generating services or service bundles.

The present invention and exemplary embodiments described herein are not considered restrictive of the architecture and design in that modifications or alterations to the physical architecture and/or design could be implemented and still fall within the scope and breadth of the present invention. It will be appreciated by those of ordinary skill in the art that the present invention can be embodies in other specific forms without departing from the spirit, scope or characteristics of the present invention. The scope of the invention is indicated by the appended claims rather than the foregoing description, and all changes that come within the meaning and range of equivalents thereof are intended to be embraced therein.

We claim:

1. A system for dynamic service activation of a plurality of internet protocol services comprised of:
an intelligent central data repository which utilizes a directory for the storage of a plurality of information;
an internet protocol network attached to said directory which is comprised of a plurality of network equipment and at least one operations systems; and
a plurality of data representations which correspond with said plurality of internet protocol services,
wherein upon a modification to said plurality of internet protocol services or said plurality of network equipment said system automatically updates the corresponding said plurality of information stored on said intelligent central data repository with a set of new data from said modification, transforms said set of new data from said modification into a plurality of data formats for use by each one of said at least one operations system, and said system updates in real time said at least one operations systems and said plurality of network equipment which interact with plurality of internet protocol services or network equipment was modified.

2. The system of claim, wherein said plurality of network equipment is comprised of at least one application server, at least one router, and at least one piece of customer premises equipment.

3. The system of claim 1, wherein said at least one operations system consists of a billing operations system, an ordering operations system, and a network management operations system.

4. The system of claim 1, wherein said modification to said plurality of internet protocol services or said plurality of network equipment is an addition of said plurality of internet protocol services or said plurality of network equipment.

5. The system of claim 1, wherein said modification to said plurality of internet protocol services or said plurality of network equipment is an alteration of said plurality of internet protocol services or said plurality of network equipment.

6. The system of claim 1, further comprising a web interface for said intelligent central data repository.

7. The system of claim 1, wherein said update of said at least one operations systems is performed by said intelligent central data repository pushing said set of set of new data to said at least one operations systems.

8. The system of claim 1, wherein said update of said at least one operations system is performed by said intelligent central data repository signaling said at least one operations systems to pull said set of set of new data from said intelligent central data repository.

9. The system of claim 1, wherein said update of said at least one operations system is performed by said at least one operations systems periodically pulling said set of set of new data from said intelligent central data repository.

10. The system of claim 1, wherein said intelligent central data repository periodically checks each one of said at least one operations system for modifications.

11. The system of claim 1, wherein said intelligent central data repository periodically checks each one of said plurality of network devices for modifications.

12. The system of claim 1, wherein said plurality of data representations are comprised of a plurality of global data representations which correspond with said plurality of internet protocol services, and a plurality of exchanged local data representations which mirror a set of data stored in each of said operations systems, wherein said exchanged local data representations are exchanged across said plurality of operations systems to activate said internet protocol services.

13. The system of claim 1, wherein said datastore is a directory.

14. The system of claim 1, wherein said datastore is a database.

15. A method for activating an internet protocol service utilizing a dynamic activation system comprising the steps of:
accessing an ordering operations system, from a plurality of operation systems, using a web browser and entering a plurality of subscriber information and a plurality of subscriber device and service information; wherein said ordering operations system updates said plurality of subscriber information and plurality of subscriber device and service information located in an intelligent central data repository;
creating a set of exchanged local data and a set of global data representations by said intelligent central data repository;
determining which of said plurality of operations systems need updating from said set of exchanged local data or said global data representations;
updating said plurality of operations systems which need updating with said set of exchanged local data or said global data representations;
determining an internet protocol address and a configuration file corresponding to said internet protocol service by said intelligent central data repository;
updating a plurality of server information with said internet protocol address and said configuration file by said intelligent central data repository;
updating a monitoring operations system, from said plurality of operations systems, with said internet protocol address and said plurality of subscriber device and service information; and
transmitting said configuration file to a subscriber device for activation.

16. The method of claim 15, wherein said updating is performed by said intelligent central data repository pushing said set of exchanged local data to said corresponding ones of said plurality of operations systems.

17. The method of claim 15, further comprising the step of determining which ones of a set of attached network devices get updated by said set of exchanged local data, wherein said updating is performed by said intelligent central data repository pushing said set of exchanged local data to said corresponding set of attached network devices.

17. The method of claim 15, wherein said updating is performed by said intelligent central data repository signaling said corresponding said plurality of operations systems to pull said set of exchanged local data from said intelligent central data repository.

18. The method of claim 15, further comprising the step of determining which ones of a set of attached network devices get updated by said set of exchanged local data, wherein said updating is performed by said intelligent central data repository signaling said corresponding set of attached network devices to pull said set of exchanged local data from said intelligent central data repository.
